(19) United States
(12) Patent Application Publication
(10) Pub. No.: US 2006/0129769 A1
(43) Pub. Date: Jun. 15, 2006

(54) System and method for migration to manufactured information handling systems

(76) Inventors: Shaofei Chen, Austin, TX (US); Marc Jarvis, Belton, TX (US); Chandar Kamalanathan, Austin, TX (US); Jefferson Raley, Austin, TX (US)

Correspondence Address: HAMILTON & TERRILE, LLP, P.O. BOX 203518, AUSTIN, TX, 78720, US

(21) Appl. No.: 11/008,703

(22) Filed: Dec. 9, 2004

(51) Int. Cl. G06F 12/16

(52) U.S. Cl. 711/162

(57) ABSTRACT

Data migration directly from legacy to replacement information handling systems is managed over a set of one or more switches. The legacy information handling system boots with a manufacturing operating system provided from a data migration information handling system server and runs a data migration application also provided from the server. Running the data migration application over the manufacturing operating system avoids password protection of the legacy information handling system. A pair of target storage device keys interface with a legacy and associated replacement system to aid in location of the replacement system on the network for direct system-to-system data transfer.

### BACKGROUND OF THE INVENTION

1. Field of the Invention

The present invention relates in general to the field of information handling system manufacture, and more particularly to a system and method for automated information handling system data migration in a scalable production environment.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Most modern organizations rely on a number of information handling systems to accomplish daily organization tasks and objectives, often having an information handling system assigned to each organization member. Information handling systems generally have a life cycle of several years before they are replaced, usually to upgrade to systems having more capable components for storing and processing information. During a typical information handling system useful lifespan, large quantities of information are usually processed and stored by the system's user. In addition, information handling system users tend to configure their individual systems in a manner that aids in the efficient accomplishment of the user's organizational tasks. For instance, users often build individualized templates, forms, network settings and desktop settings that reduce the time involved in repetitive tasks, such as filling out daily reports. Understandably, organizational transition from existing to new information handling systems often cause anxiety among organization members who worry that stored information and user-integrated efficiencies of existing information handling systems will be lost with the delivery of the replacement systems.

In order to aid in the transition from existing to replacement information handling systems, a number of data migration applications are typically used by an organization's information technology staff, such as Desktop DNA, Aloha Bob and InteliMover. Data migration typically involves extracting large amounts of information from a legacy information handling system and storing the information in appropriate locations of a designated replacement information handling system so that desired system settings, application settings and files are available on the replacement system. Conventional use of existing data migration applications typically involves coupling a cable between the legacy and replacement information handling systems and then running the data migration application on the legacy system to transfer the information. The process of connecting systems and running the data migration application tends to be labor intensive, error prone and not scalable. For instance, when running the data migration application on the legacy information handling system, the information technology staff typically must identify the appropriate replacement system and have all of the passwords used on the legacy system to transfer password protected information to the replacement system. If the data migration is performed over a network, the data migration process is slowed by server information handling system processing and information technology staff configuration of appropriate network IP addresses.

### SUMMARY OF THE INVENTION

Therefore a need has arisen for a system and method which provides automated data migration from legacy information handling systems to replacement information handling systems in a scalable production environment.

In accordance with the present invention, a system and method are provided which substantially reduce the disadvantages and problems associated with previous methods and systems for performing data migration from legacy information handling systems to replacement information handling systems. Legacy and replacement information handling systems interface directly through a set of one or more switches to communicate information from each legacy information handling system to designated replacement information handling systems.

More specifically, data migration is performed directly between a legacy and replacement information handling system through a set of one or more interconnected switches. A data migration server interfaces through the switches to allow the legacy information handling system to boot from a manufacturing operating system of the server, such as WINPE, and to load data migration monitor application from the server. The replacement information handling system boots to the operating system on its hard disc drive, such as WINDOWS XP, and retrieves the data migration monitor application, a data migration application, data migration templates and data migration scripts from the data migration server. The migration monitor application and an associated target identification engine available from the server runs on the replacement and legacy information handling systems so that the replacement system broadcasts through the set of one or more switches a unique identifier that designates its legacy information handling system. For instance, common identification information is used by the target identification engine from a storage device key pair having one key connected to the legacy system and a matching key connected to the replacement system. Location of the unique identifier by the target identification engine allows an exchange of IP addresses to have a direct migration of information from the legacy to the replacement system through the switches with the data migration application running on the replacement information handling system and receiving information from the IP address of the identified legacy system. The data migration monitor application running on the replacement and legacy systems determines the success or failure of the data migration.

The present invention provides a number of important technical advantages. One example of an important technical advantage is that data migration from legacy information handling systems to replacement information handling systems is automated for scalable use in a production environment with reduced labor and risk of errors. Network-based booting of legacy information handling systems to the manufacturing operating system avoids delays and security risks associated with information technology staff input of passwords to perform data migration and also ensures that the legacy systems hard disc drive remains intact. Broadcasting of identification information to obtain IP addresses for legacy and replacement information handling systems ensures quick and accurate configuration of the data migration application. Switch-to-switch data transfers eliminates delays otherwise introduced by information transfer through server information handling systems while network based data migration allows a server information to flexibly update data migration tools, templates and scripts. Rapid and efficient data migration allows a manufacturer to perform data migration to information handling systems ordered by an individual or organization with minimal disruption by shipping the legacy information handling system to the manufacturer during an idle period, such as during a weekend, so that the manufacturer completes the data migration and returns the replacement information handling system to the individual or organization by the end of the idle period. Detailed data migration logs copied to the data migration server remain available to troubleshooting and performance analysis of replacement information handling systems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for migrating data from a legacy to a replacement information handling system; and

FIG. 2 depicts a flow diagram of a process for migrating data from a legacy to a replacement information handling system.

### DETAILED DESCRIPTION

An architecture and process for automated data migration from legacy to replacement information handling systems scales for use in an information handling system production environment so that desired system settings, application settings and files are available on replacement information handling systems delivered from the manufacturer. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

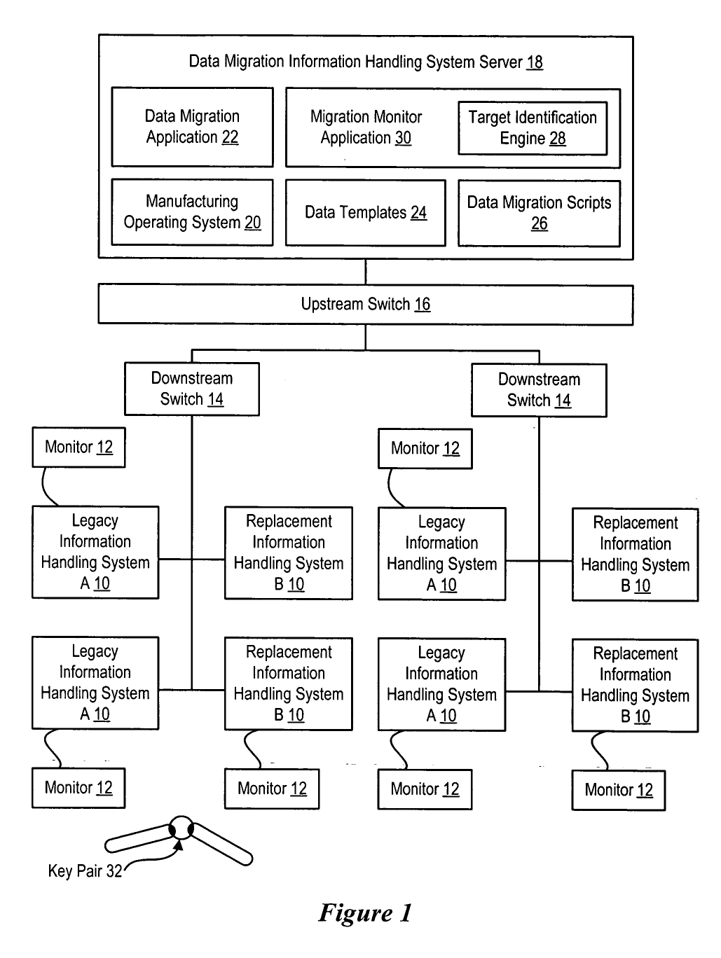

Referring now to FIG. 1, a block diagram depicts a system for migrating data from a legacy to a replacement information handling system. Plural information handling systems 10 having display monitors 12 interface with each other through a set of interconnected downstream switches 14. Information handling systems 10 include legacy information handling systems that have system settings, application settings and files created during operational use, such as in an organization or by an individual. Information handling systems 10 also include replacement information handling systems that are built to replace the legacy systems. For instance, an organization places orders with a manufacturer to replace its existing information handling systems with newly manufactured systems and then ships the existing systems to a designated manufacturer location in order to have the manufacturer migrate information from the existing systems to the newly manufactured systems. After data migration, the newly manufactured systems are returned to the organization to replace the existing systems complete with the migrated data, thus reducing the disruption experienced by the organization by replacement of existing information handling systems.

In order to reduce technician interaction with legacy information handling systems 10, these systems are booted through an upstream switch 16 by a data migration information handling system server 18. For instance, at power-up of a legacy information handling system 10A, a technician selects a network boot option through monitor 12, such as with a PXE boot environment, that boots the legacy system with a manufacturing operating system 20 provided from data migration information handling system server 18. As an example, the use of WINDOWS PE as manufacturing operating system 20 allows transfer of files from a legacy information handling system 10A without invoking password protection of password protected files. After boot, manufacturing operating system 20 automatically initiates a data migration monitor application 30 from data migration information handling system server 18. A replacement information handling system 10B associated with the legacy system 10A boots to the native operating system on its hard disc drive, such as WINDOWS XP, and retrieves a data migration application 22, data migration templates 24 and data migration scripts 26 that are downloaded to through upstream switch 16. Storing templates 24 and scripts 26 on server 18 allows flexible adjustments to the data migration process by changes at server 18. For instance, data migration templates 24 identify information designated for migration, such as word processing files, and information designated as not allowed for migration, such as MP3 files. Data migration scripts 26 perform predetermined actions during the data migration process, such as modifying predetermined settings like screen saver, power management, virus scan and firewall settings that could interfere with or slow down the data migration process. The original settings are recorded and then restored to the legacy and replacement information handling systems upon the completion of the data migration.

Data migration monitor application 30 retrieves and runs a target identification engine 28 on replacement information handling system 10B to aid with smooth processing of multiple data migrations. A legacy information handling system 10A and its associated target replacement information handling system 10B are identified with a USB key memory stick pair 32. A first memory stick of the pair connects to legacy information handling system 10A and a second memory stick of the pair connects to a replacement information handling system 10B, with each memory stick having a common unique identifier. Target identification engine 28 runs on replacement information handling system 10B to broadcast queries to other information handling systems interfaced with downstream switches 14 until finding a response having the matching unique identifier. Target identification engine 28 determines the IP address of the information handling system that responds with the unique identifier and initiates data migration to the IP address so that the information transfer occurs directly through downstream switches 14 and avoids delays introduced by server processing. Data migration application 22 then runs on replacement information handling system 10B to retrieve the information from the associated legacy information handling system 10A. Migration monitor application 30 manages the operation of target identification engine 28 and data migration application 22 and monitors the progress of the data migration through audit of the transferred information. Migration monitor application 30 indicates a success with a green colored monitor screen and a failure with a red colored monitor screen. Cumulative data migration tracking is maintained at server 18.

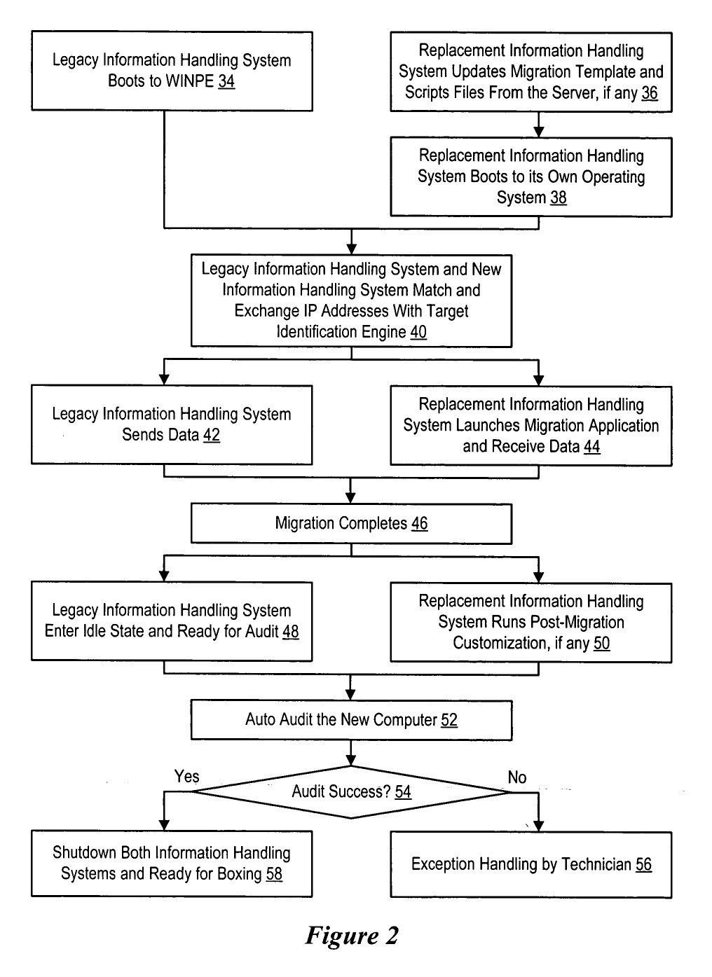

Referring now to FIG. 2, a flow diagram depicts a process for migrating data from a legacy to a replacement information handling system. The process begins at step 34 with booting of the legacy information handling system to the WINPE operating system from a network location. At step 36 the replacement information handling system downloads any updated data migration templates and script files and, at step 38, boots to its own operating system. At step 40, the legacy and replacement information handling systems find each other by matching the unique identifiers from the USB memory stick key pair and exchange IP addresses. At step 42 the legacy information handling system sends information to the replacement information handling system IP address and, at step 44 the replacement information handling system initiates the data migration application to receive information from the legacy information handling system IP address. At step 46 the data migration completes and the systems prepare to audit for accurate data transfer. At step 48, the legacy information handling system enters an idle state and at step 50 the replacement information handling system runs post-migration customization, such as restoring disabled settings, so that an audit may be performed at step 52. If at step 54 the audit fails, the process continues to step 56 for exception handling by a technician. If at step 54 the data migration audit indicates a successful data transfer, the process completes at step 58 with power down of the information handling systems for shipping.

Although the present invention has been described in detail, it should be understood that various changes, substitutions and alterations can be made hereto without departing from the spirit and scope of the invention as defined by the appended claims.

What is claimed is:

1. A system for migrating data from legacy information handling systems to replacement information handling systems, the system comprising:
at least one switch operable to interface a legacy information handling system with an associated replacement information handling system;
a server information handling system interfaced with the switch and operable to communicate through the switch to the legacy and replacement information handling systems;
a manufacturing operating system disposed on the server and operable to boot the legacy information handling system through the switch; and
a data migration application disposed on the server and operable to run on the replacement information handling system to migrate data from the legacy information handling system to the replacement information handling system.

2. The system of claim 1 further comprising data migration scripts disposed on the server information handling system and operable to interact with the data migration application to perform predetermined data migration functions.

3. The system of claim 2 wherein a predetermined data migration function comprises selectively modifying one or more legacy information handling system functions before initiating data migration and re-enabling the one or more functions at the legacy and replacement information handling systems after completing data migration.

4. The system of claim 3 wherein the modified function is a screen saver application.

5. The system of claim 3 wherein the modified function is a power management application.

6. The system of claim 1 further comprising:
a target identification engine disposed on the server information handling system and operable to run on the replacement and legacy information handling systems; and
plural target identification keys having unique identification information, the target identification keys operable to connect to the legacy and replacement information handling systems;
wherein the target identification engine reads the identification information from the connected target identification key and broadcasts to information handling systems interfaced with the one or more switches to locate an information handling system connected to a target identification key and having the common identification information.

7. The system of claim 6 wherein the target identification key is a USB memory stick storing the common identification information.

8. The system of claim 7 wherein the target identification engine locates the IP address associated with the replacement information handling system having the common identification information.

9. The system of claim 1 wherein the data migration application is further applicable to migrate data from the legacy information handling system to the replacement information handling system directly through the one or more switches.

10. A method for migrating data from a legacy information handling system to a replacement information handling system, the method comprising:
interfacing the legacy information handling system with a set of one or more interconnected switches;
interfacing the replacement information handling system with the set of switches;
booting the legacy information handling system with a manufacturing operating system provided through the one or more switches from a network location;
running a data migration application, the data migration application provided through the one or more switches from the network location; and
migrating information from the legacy information handling system to the replacement information handling system through the set of one or more switches.

11. The method of claim 10 wherein migrating information further comprises migrating information from the legacy information handling system to the replacement information handling system directly through the set of one or more switches.

12. The method of claim 10 further comprising:
bypassing password protection of at least some information of the legacy information handling system by running the legacy information handling system on the manufacturing operating system.

13. The method of claim 10 further comprising:
modifying one or more settings of the legacy information handling system;
storing the modified settings;
migrating the information with the settings modified; and
restoring the modified settings at the legacy and replacement information handling systems after completing the migrating of the information.

14. The method of claim 13 wherein the modified settings comprise screen saver settings.

15. The method of claim 13 wherein the modified settings comprise power management settings.

16. The method of claim 10 further comprising:
associating a unique identifier with the legacy information handling system;
associating the unique identifier with the replacement information handling system;
associating the IP address of the replacement information handling system and the legacy information handling system by locating the unique identifier; and
migrating the information from the legacy information handling system IP address directly to the replacement information handling system IP address.

17. The method of claim 16 wherein associating the unique identifier with the legacy and replacement information handling systems further comprises connecting a USB key pair to the legacy and replacement information handling systems, each of the USB key pair storing the unique identifier.

18. A method for communicating information from a source information handling system to a target information handling system through a network, the method comprising:
interfacing a first storage device with the source information handling system, the first storage device having a unique identifier;
interfacing a second storage device with the target information handling system, the second storage device having the unique identifier;
broadcasting the unique identifier through the network to associate the target information handling system network location with the source information handling system network location;
determining the IP address of the network locations; and
communicating the information from the source information handling system to the target information handling system with the network location IP addresses.

19. The method of claim 18 wherein the first and second storage devices are a matching pair of USB memory sticks.

20. The method of claim 18 wherein communicating the information further comprises communicating the information directly from the source information handling system to the target information handling system through a switch.
